(19) United States
(12) Patent Application Publication
(10) Pub. No.: US 2020/0347940 A1
(43) Pub. Date: Nov. 5, 2020

(54) VALVE CARTRIDGE ASSEMBLY

(71) Applicant: Dana Canada Corporation, Oakville (CA)

(72) Inventors: Anis MUHAMMAD, Mississauga (CA); Silvio E. TONELLATO, Hamilton (CA)

(21) Appl. No.: 16/862,516

(22) Filed: Apr. 29, 2020

Related U.S. Application Data
(60) Provisional application No. 62/840,851, filed on Apr. 30, 2019.

(51) Int. Cl. F16K 1/36; F16K 31/20; F16K 31/122; F16K 27/02

(52) U.S. Cl. CPC F16K 1/36; F16K 27/02; F16K 31/1223; F16K 31/20

(57) ABSTRACT

A one-piece valve cartridge assembly for controlling fluid flow in a vehicle has a valve actuator, first and second valve members and a valve cap. The actuator has a piston which is extendable and retractable along a longitudinal axis, with the valve members being provided at opposite ends of the actuator body. The valve cap includes a central, longitudinally extending sleeve portion to receive the free end of the piston with an interlocking fit. The piston may have an annular groove which interlocks with an annular bead inside the sleeve portion of the valve cap. The interlocking fit prevents separation of the assembly components during manufacturing and shipping, with axial alignment of the assembly is maintained by a close fit between the piston and the sleeve portion.

### CROSS-REFERENCE TO RELATED APPLICATION

This application claims priority to and the benefit of U.S. Provisional Patent Application No. 62/840,851 filed Apr. 30, 2019, the contents of which are incorporated herein by reference.

### TECHNICAL FIELD

The present disclosure relates to a one-piece valve cartridge assembly to be incorporated into a valve for controlling fluid flow in a vehicle.

### BACKGROUND

Valves are used extensively to control fluid flow in vehicles, including conventional motor vehicles powered by internal combustion engines, hybrid vehicles and battery electric vehicles.

In a typical valve construction, a valve cartridge is inserted into a housing which defines a valve chamber and a plurality of fluid ports, to produce a valve. The valve may be a separate component of a fluid circulation system of a vehicle, or it may be integrated with another vehicle component such as a heat exchanger, powertrain component, etc. The valve cartridge includes a number of components, such as an actuator, springs, valve members, valve seats, and sealing or closure members. The valve housing includes fluid ports and fittings for connection to a fluid circulation system of the vehicle. Some of the cartridge components may be pre-assembled before insertion into the housing, however, these components may only be loosely held together. In a typical case, an automotive parts supplier will assemble the valve cartridge and the valve housing to produce a finished valve which is then shipped to a customer, such as a vehicle manufacturer.

However, in some cases the automotive parts supplier will supply only the valve cartridge to the customer, and the customer will insert the cartridge into a valve housing. Therefore, the parts supplier must ensure that the valve cartridge remains intact and retains its desired shape and/or alignment during shipping and handling, such that it can be easily and reliably dropped into the housing by the customer in its manufacturing facility.

There is a need for an improved valve cartridge construction which will satisfy the above objectives, and which will also provide other advantages such as reduced weight, cost and pressure drop.

### SUMMARY

In accordance with an aspect of the present disclosure, there is provided a valve cartridge assembly. The valve cartridge assembly comprises a valve actuator, first and second valve members, a first spring member, and a valve cap.

According to an aspect, the valve actuator comprising an actuator body having a first end and a second end, and a piston which extends along a longitudinal axis from the first end of the actuator body, wherein the piston is extendable and retractable along the longitudinal axis.

According to an aspect, the first valve member is provided at the second end of the actuator body, and the second valve member is provided at the first end of the actuator body.

According to an aspect, the first spring member has a first end which is attached to the second end of the actuator body.

According to an aspect, the valve cap comprises: (i) a valve closure cap adapted to seal against an inner wall of a valve housing, the valve closure cap having a first end and a second end; and (ii) a central, longitudinally extending sleeve portion adapted to receive a distal end of the piston, the sleeve portion having an open end, a hollow interior and a generally cylindrical inner wall surface.

According to an aspect, the distal end of the piston is received inside the sleeve portion with an interlocking fit.

According to an aspect, the valve cap further comprises the valve cap further comprises an annular end portion longitudinally spaced from the valve closure cap and defining a central fluid opening, the annular end portion having a first face and a second face, wherein the second face defines an annular valve seat adapted to seal with the second valve member.

According to an aspect, the valve cap further comprises a plurality of longitudinally extending struts extending between and attached to the second end of the valve closure cap and the first face of the annular end portion.

According to an aspect, the central, longitudinally extending sleeve portion projects from the second end of the valve closure cap.

According to an aspect, the central, longitudinally extending sleeve portion comprises an internal, longitudinally extending bore.

According to an aspect, the piston has an annular groove on its outer surface, proximate to the distal end thereof; and the generally cylindrical inner wall surface of the sleeve portion is provided with an annular bead which is closely received inside the annular groove of the piston.

According to an aspect, the distal end of the piston is closely received inside the sleeve portion.

According to an aspect, the sleeve portion is provided with a plurality of axial slots extending from the open end of the sleeve portion toward the second end of the valve closure cap; and the slots separate the sleeve portion into a plurality of axially extending fingers which are flexible in radially inward and outward directions during insertion of the piston into the sleeve portion.

According to an aspect, the second valve element is integrally formed with the actuator body and comprises an annular surface at the first end of the actuator body.

According to an aspect, the valve actuator is a thermal actuator or an electronic actuator.

According to an aspect, the actuator body is generally cylindrical; the valve cartridge assembly further comprises a second spring member comprising a coil spring which extends around the actuator body; and the first valve element comprises an annular disc which is slidably received over the second end of the actuator body, between the first and second spring members.

According to an aspect, the second end of the actuator has an annular groove; and the first spring member has a first proximal end which is secured in the annular groove.

According to an aspect, the first end of the valve closure cap forms an outer surface of the valve cartridge assembly; and the first end of the valve closure cap is provided with a plurality of depressions which are shaped for engagement with a tool for inserting and removing the valve cartridge assembly from a valve housing.

According to an aspect, the depressions are wedge shaped and centrally arranged around a center of the end face, the depressions being separated by webs and surrounded by a flat, annular surface.

According to an aspect, the struts are arranged circumferentially and wherein spaces between the struts provide fluid flow passages.

According to an aspect, the valve cap comprises three struts which are circumferentially spaced apart from one another by about 120 degrees, and the spaces between the struts are substantially greater in area than the struts themselves.

According to an aspect, the annular valve seat of the annular end portion is recessed relative to the second face of the annular end portion, such that the second valve member is at least partially received inside the annular ring portion when the piston is in a non-actuated, retracted position.

According to an aspect, the annular end portion has an outer surface which is provided with an annular sealing rib which is adapted to sealingly engage an inner surface of the valve housing.

### BRIEF DESCRIPTION OF THE DRAWINGS

Exemplary embodiments of the present disclosure will now be described, by way of example, with reference to the accompanying drawings, in which:

FIG. 1 is a perspective view showing a valve cartridge assembly according to an embodiment, in a disassembled state;

FIG. 2 is a central, longitudinal cross section through the valve cartridge assembly of FIG. 1;

FIG. 3 is a perspective view of the valve cap of the valve cartridge assembly of FIG. 1, from the second end thereof;

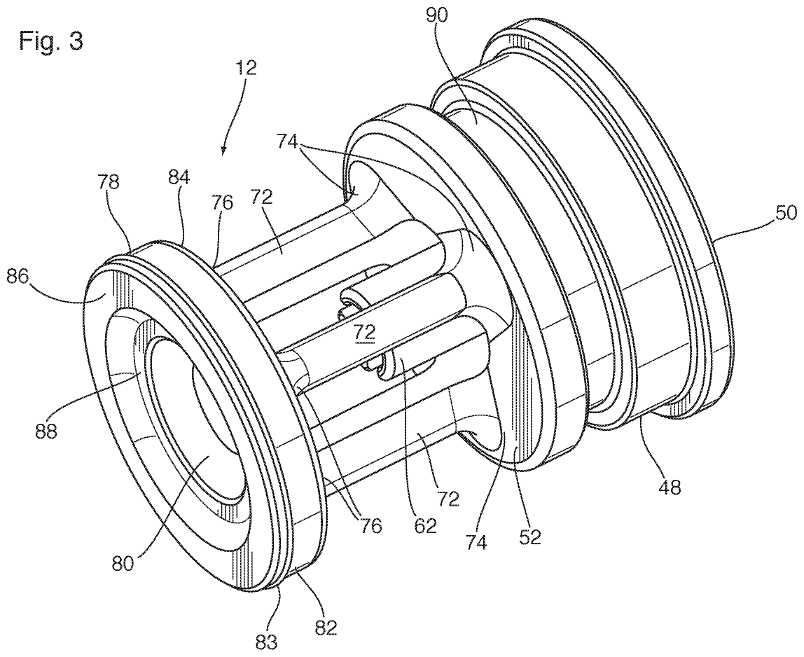

FIG. 4 is a perspective view of the valve cap of the valve cartridge assembly of FIG. 1, from the first end thereof;

FIG. 5 is a central, longitudinal cross-section through the valve cap of FIGS. 3 and 4;

FIG. 6 is a transverse cross-section through the valve cap of FIGS. 3 and 4;

FIG. 7 is an enlarged central longitudinal cross-section through the valve cartridge assembly, showing the piston of the actuator separated from the sleeve portion of the valve cap;

FIG. 8 is an enlarged central longitudinal cross-section through the valve cartridge assembly, showing the piston of the actuator partly received in the sleeve portion of the valve cap;

FIG. 9 is an enlarged central longitudinal cross-section through the valve cartridge assembly, showing the piston of the actuator fully received in the sleeve portion of the valve cap;

FIG. 10 is a central longitudinal cross-section through a valve incorporating the valve cartridge assembly of FIG. 1;

FIG. 11 is a central longitudinal cross-section through a valve incorporating a valve cartridge assembly according to a second embodiment; and

FIG. 12 is a perspective view of the valve cap of the valve cartridge assembly according to the second embodiment.

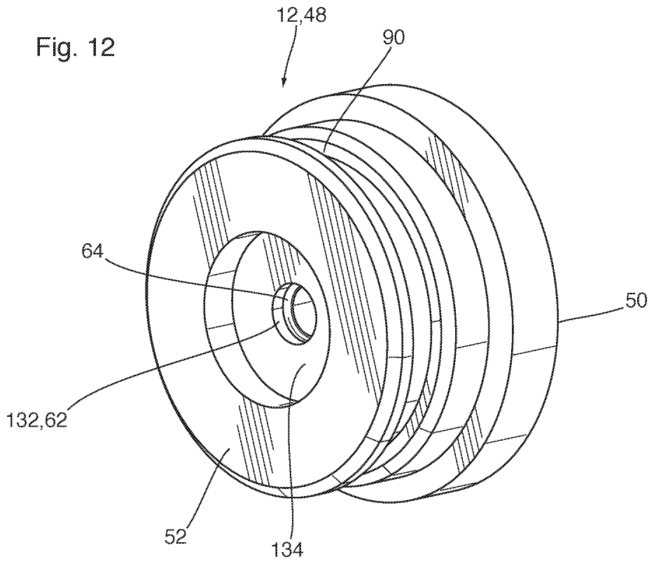

### DETAILED DESCRIPTION

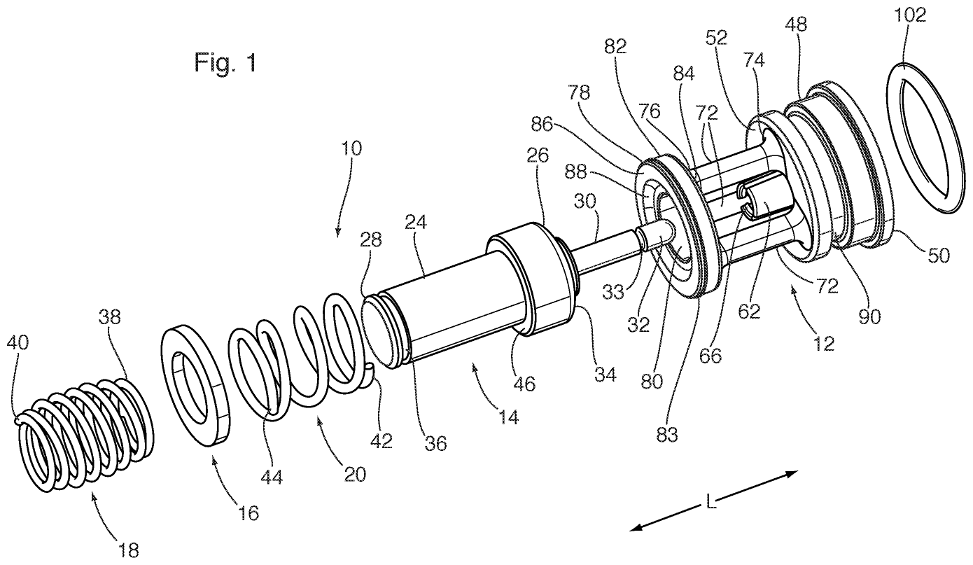

The drawings illustrate a valve cartridge assembly 10 comprising a valve cap 12, a valve actuator 14, a first valve member 16, a second valve member 34, a first spring member 18 and optionally a second spring member 20. These components are shown in a disassembled state in FIG. 1.

The valve cartridge assembly 10 defines a longitudinal axis L. As used herein, terms such as “axial” and “longitudinal” are understood as meaning along or parallel to the longitudinal axis L.

The valve actuator 14 comprises a generally cylindrically shaped actuator body 24 having a first end 26 and a second end 28 spaced apart along longitudinal axis L. The valve actuator 14 further comprises a piston 30 which extends axially from the first end 26 of actuator body 24, wherein the piston 30 is extendable and retractable along the longitudinal axis L. Except as otherwise indicated below, the drawings show the piston 30 in its retracted position. The piston 30 comprises a cylindrical metal shaft having a distal end 32 which may be rounded, and having an annular groove 33 on its outer surface for reasons which will be explained below. The annular groove 33 may be located proximate to the distal end 32 of piston 30.

The second valve member 34 is provided at the first end 26 of actuator body 24 and, in the present embodiment, is integrally formed with the actuator body 24 and comprises an annular surface at the first end 26 thereof. The first end 26 of actuator body 24 may be enlarged in order to accommodate the diameter of the second valve disc 34. However, it will be appreciated that the second valve member 34 may instead comprise a separate valve disc, in the form of an annular washer, similar to the second valve disc described in commonly assigned Publication No. US 2016/0349770 A1. The second end 28 of actuator body 24 includes an annular groove 36 for reasons which will be explained below.

The valve actuator 14 in the present embodiment is a thermal actuator, and may sometimes be referred to as a thermal motor or wax motor. The actuator body 24 contains a thermally sensitive material (not shown) which expands when heated above a threshold temperature, and which contracts when cooled below the threshold temperature. The thermally sensitive material may comprise a wax material. Expansion of the thermally sensitive material causes the piston 30 to extend axially, and contraction of the thermally sensitive material allows the piston 30 to retract. Therefore, the actuator body 24 acts as a temperature sensing device which responds to temperature changes in a fluid flowing through the valve.

Alternatively, the valve actuator 14 may comprise an electronic actuator which extends and retracts the piston 30 in response to electronic signals received from a temperature sensor, which may be located elsewhere in the vehicle, and senses the temperature of a vehicle component and/or fluid.

The first valve member 16 is shown as being a separate component in the form of an annular disc or washer which is slidably received over the second end 28 of the actuator body 24, between the first and second spring members 18, 20. In some embodiments, however, the first valve member 16 may instead be rigidly secured to the second end 28 of actuator body 24, and may be integrally formed therewith.

The first spring member 18 comprises a coil spring, and may also be referred to as a return spring. The first spring member 18 has a first proximal end 38 which is secured in the annular groove 36 at the second end 28 of valve body 24, and a second distal end 40 which projects axially away from the second end 28 of valve body 24. As will be further explained below, the first spring member 18 is compressed axially by the actuator body 24 when the piston 30 is extended, and urges the piston 30 back to its retracted position, for example when the thermally sensitive material in the actuator body 24 returns to its original contracted state.

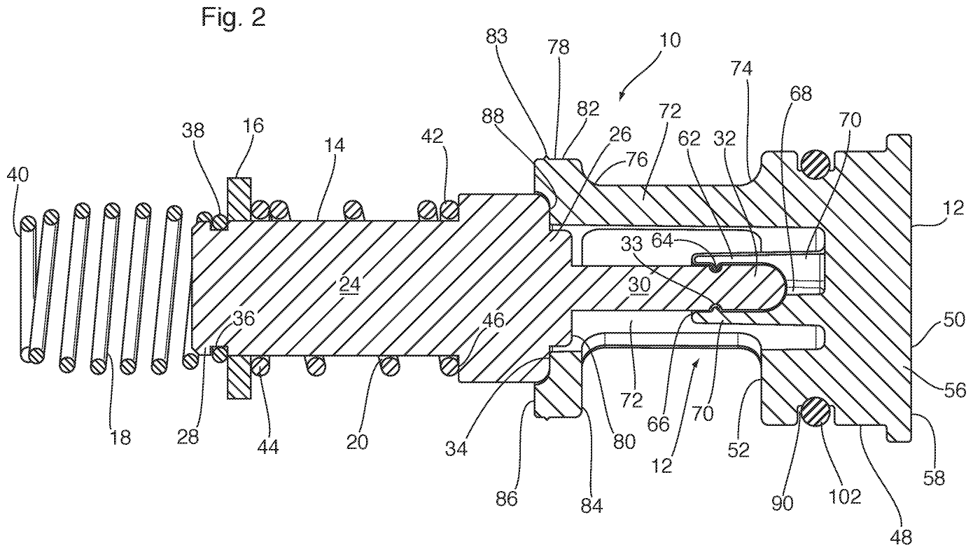

It can be seen from the cross-section of FIG. 2 that the diameter of the opening in the first valve member 16 is smaller than the outer diameter of the first proximal end 38 of first spring member 18, and therefore the first spring member 18 also prevents the first valve member 16 from separating from the actuator body 24.

The second spring member 20 comprises a coil spring, and may also be referred to as an override spring. The second spring member 20 extends around the outer surface of the actuator body 24, having a first end 42 which engages an axial shoulder 46 of the enlarged first end portion of the actuator body 24, and a second end which engages the first valve member 16. The second spring member 20 is under compression and thus urges the first valve member 16 toward the second end 28 of actuator body 24. The second spring member 20 also allows the first valve member 16 to be urged toward the first end 26 of actuator body 24 under certain operating conditions, such as a high fluid pressure acts on the first valve member 16 with sufficient force to compress the second spring member 20. Where a pressure relief is not desired or needed, the first valve member 16 may instead be rigidly secured to the second end 28 of actuator body 24, or be integrally formed therewith in a similar manner to the second valve member 34.

The valve cap 12 serves several functions and includes several components, as now described below.

The valve cap 12 includes a generally cylindrical valve closure cap 48 having a first end 50 and a second end 52. The first end 50 forms an outer surface of the valve cartridge assembly 10 and, as further discussed below, the first end 50 is accessible from outside a valve housing into which the valve cartridge assembly 10 is inserted. The valve closure cap 48 has an outer cylindrical surface which is provided with an annular groove 90 adapted to receive a resilient sealing element 102 in the form of an O-ring, as further described below.

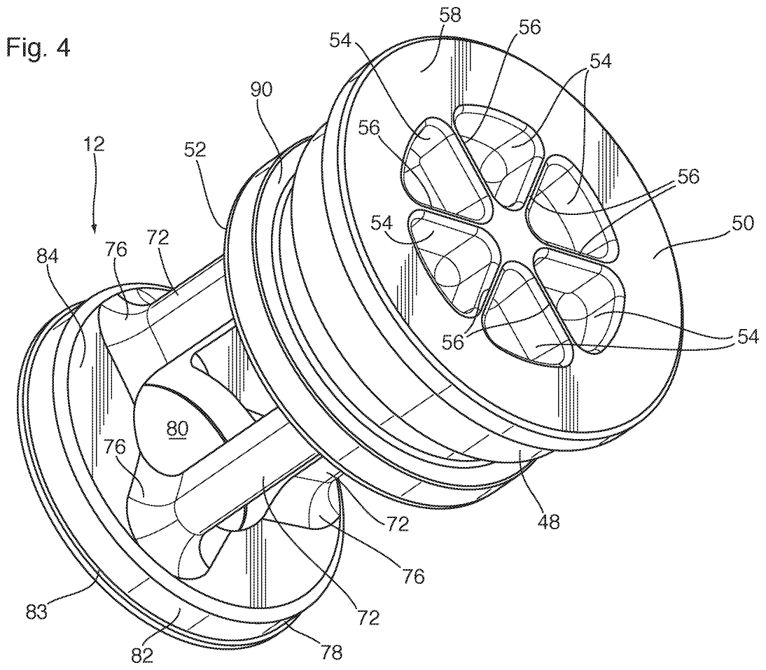

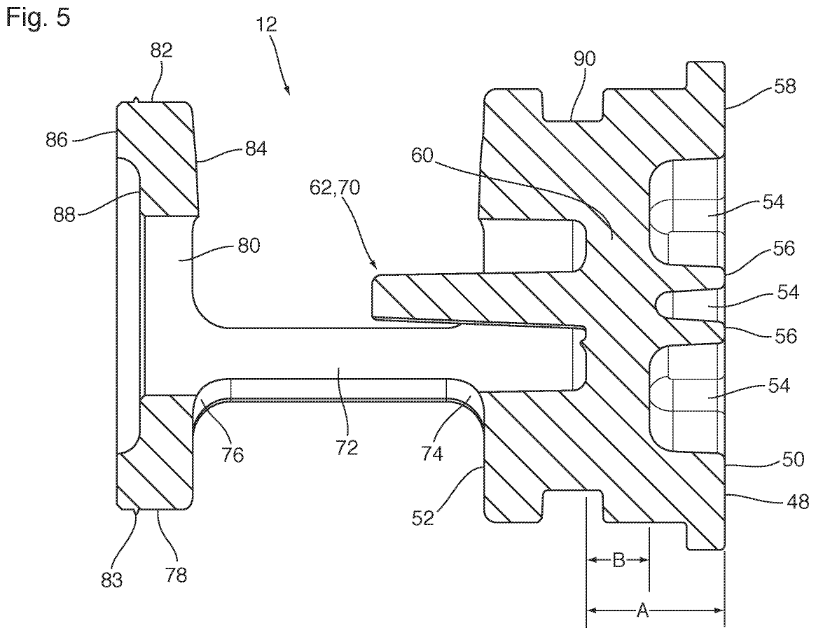

The first end 50 of valve closure cap 48 is provided with one or more depressions 54 which are shaped for engagement with a tool for inserting and removing the valve cartridge assembly 10 from a housing. The depressions 54 are shown in FIG. 4 as being wedge-shaped and centrally arranged around the center of the circular end face defining the first end 50, the depressions 54 being separated by narrow webs 56. The depressions 54 are surrounded by a flat, annular surface 58. In addition to providing engagement with an installation tool, the depressions also serve to reduce the thickness of the material comprising the valve cap 12, which is typically molded from plastic. This reduction in material thickness reduces weight and material cost, and the thickness reduction can be seen at 60 in FIG. 5, and by comparing the full thickness (thickness A) of valve closure cap 48 with the reduced thickness (thickness B) in the depressions 54.

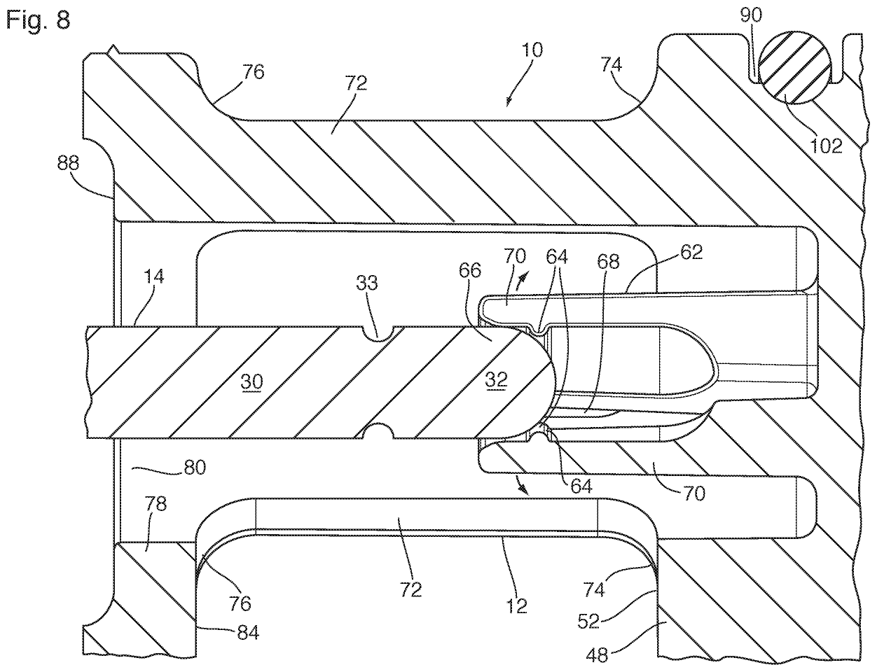

The second end 52 of valve closure cap 48 is provided with a central, axially-extending sleeve portion 62 which is adapted to receive the distal end 32 of piston 30 with an interlocking fit. The sleeve portion 62 has a generally cylindrical inner wall surface provided with an annular bead 64 projecting from the inner wall surface into the hollow interior of sleeve portion 62. As shown in FIG. 8, the annular bead 64 is shaped and sized to be closely received inside the annular groove 33 close to the distal end 32 of piston 30.

Due to the interlocking of the bead 64 and groove 33, the piston 30 will resist being pulled out of the sleeve portion 62, and therefore the interlocking bead 64 and groove 33 prevent separation of the valve cartridge assembly 10 into two separate components. This simplifies manufacturing and shipping (logistics), particularly where the valve cartridge assembly is manufactured and shipped as a separate component to a third party, where it will be “dropped” into a valve housing. Furthermore, the distal end 32 of piston 30 is closely received inside the sleeve portion 62. Both the piston 30 and sleeve portion 62 are axially aligned, and the close fit of the piston 30 inside the sleeve portion 62 assists in maintaining overall axial alignment of the valve cartridge assembly 10, which is necessary to allow easy insertion of the valve cartridge assembly 10 into a housing.

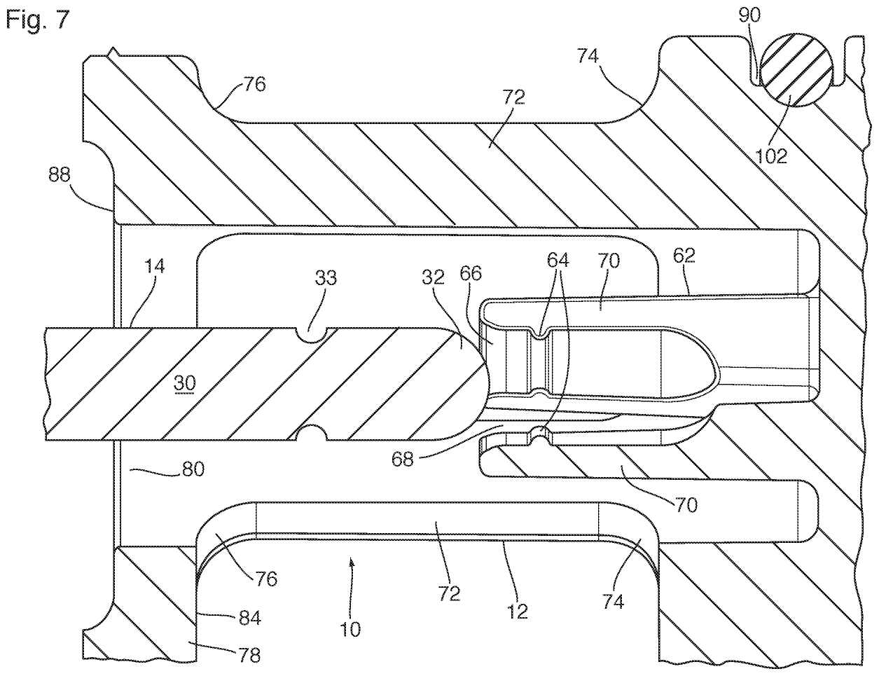

FIGS. 7 to 9 show how the distal end 32 of piston 30 is inserted into sleeve portion 62 during assembly of the valve cartridge assembly 10. As shown in FIG. 7, the distal end 32 of piston 30 is rounded and the sleeve portion 62 has a is widened open end 66 to assist in alignment and insertion of the piston 30 into sleeve portion 62.

Once the piston 30 is inserted into sleeve portion 62 to the extent shown in FIG. 8, the distal end 32 of piston 30 will come into contact with the annular bead 64, and the pushing the distal end 32 over bead 64 will cause the sleeve portion 62 to flex outwardly as shown by the curved arrows in FIG. 8. This outward flexing of the sleeve portion 62 is made possible by providing the sleeve portion with a plurality of axial slots 68 extending from the open end 66 of sleeve portion 62 toward the second end 52 of valve closure cap 48. The slots 68 separate the wall of sleeve portion 62 into a plurality of axially-extending fingers 70, which are flexible in a radially inward and outward direction during insertion of the piston 30. In the illustrated embodiment, there are three slots 68 and three fingers 70, however, it will be appreciated that the sleeve portion 62 may include two slots 68 and two fingers 70, or may include more than three slots 68 and fingers 70.

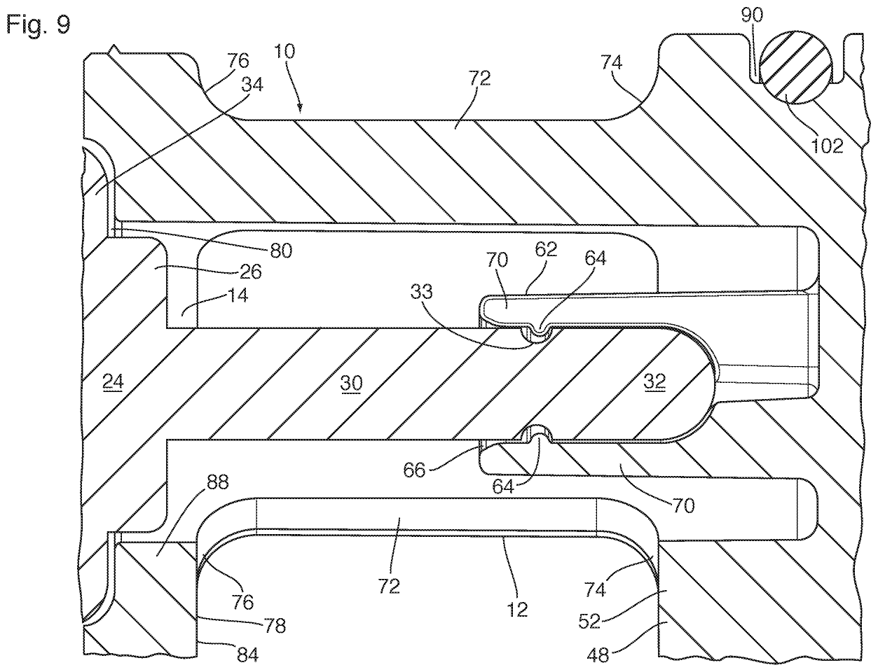

As shown in FIG. 9, once the distal end 32 of piston 30 is inserted to a sufficient extent that the annular groove 33 in piston 30 is aligned with the annular bead 64, the fingers 70 will flex radially inwardly and the annular bead 64 will be received inside the annular groove 33, thereby forming the interlocking fit between the piston 30 and the sleeve portion 62.

The second end 52 of valve closure cap 48 is also provided with a plurality of axially-extending struts 72 which are arranged circumferentially around sleeve portion 62. Each of the struts 72 has a first end 74 attached to the second end 52 of valve closure cap 48 and a second end 76 attached to an annular end portion 78 of the valve cap 12, which is further discussed below.

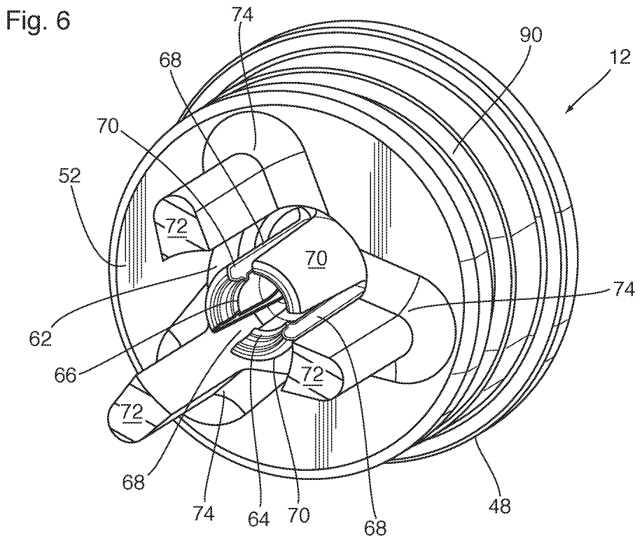

It will be appreciated that the spaces between the struts 72 provide fluid flow passages, and the valve cartridge assembly 10 minimizes the dimensions and the number of struts 72 so as to make the spaces between the struts 72 as large as possible, so as to minimize pressure drop of the fluid as it passes through the valve, and specifically through the valve cap 12. It can be seen from FIG. 6 that the valve cap 12 includes three struts 72 which are circumferentially spaced apart from one another by about 120 degrees, and that the spaces between the struts 72 are substantially greater in area than the struts 72 themselves.

The annular end portion 78 of valve cap 12 is in the form of an annular ring having a central opening 80 which permits passage of fluid between areas of the valve cartridge assembly 10 located on opposite sides of the annular end portion 78. The annular end portion 78 also has a substantially cylindrical outer surface 82 which is adapted to form a substantial seal with an inner surface of a valve housing, and which may be provided with an annular sealing rib.

The annular end portion 78 has a first face 84 to which the second ends 76 of the struts 72 are attached, and a second face 86 which defines an annular valve seat 88 which is adapted to form a fluid-tight seal with the second valve member 34 which is integrally formed with the actuator body 24. The annular valve seat 88 may be recessed relative to the second face 86. Also, in the neutral (low temperature) state of the valve cartridge assembly 10, with the piston 30 in the non-actuated, retracted position shown in FIG. 2, the second valve member 34 is seated on the valve seat 86, and because the valve seat 86 is recessed, the second valve member 34 is at least partially received inside the annular ring portion, thereby providing an additional point of engagement between the valve cap 12 and the valve actuator 14, which further helps to maintain the axial alignment of the valve cartridge assembly 10. It will be appreciated that the piston 30 will typically remain in the non-actuated, retracted position during shipping of the valve cartridge assembly 10 and during insertion of the valve cartridge assembly 10 into a valve housing.

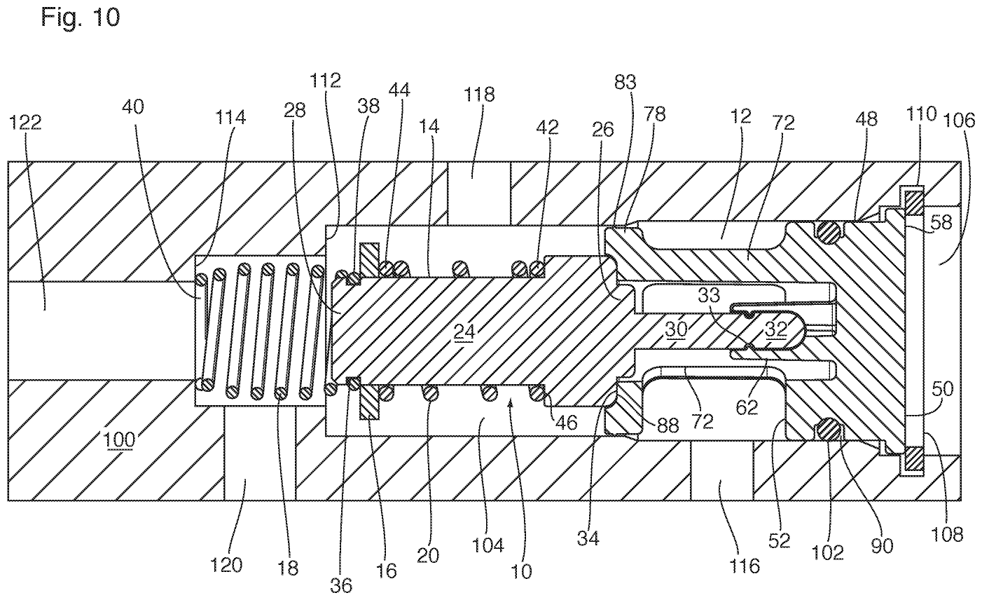

FIG. 10 shows the valve cartridge assembly 10 after it has been inserted into a valve housing 100. The valve housing 100 has a hollow valve chamber 104 and an open end 106 through which the valve cartridge assembly 10 is inserted into chamber 104. Once the valve cartridge assembly 10 is inserted, it is locked in place by resilient spring clip 108 which may be a C-shaped metal ring which has its outer portion received in an annular groove 110 just inside the open end 106, and an inner portion which engages the flat annular surface 58 at the first end 50 of the valve closure cap 48.

The valve chamber 104 has a generally cylindrical inner wall against which the outer cylindrical surfaces of the valve closure cap 48 and the annular end portion 78 are sealed. The seal between the valve closure cap 48 and housing 100 is made fluid-tight with the assistance of the O-ring 102 which is received in the annular groove 90 of the valve closure cap 48. In addition, the annular sealing rib 83 of the outer surface 82 of annular end portion engages the cylindrical inner wall of valve chamber 104 so as to prevent fluid leakage around the outer edges of annular end portion 78.

The valve chamber 104 may comprise a stepped bore with a plurality of diameter reductions located inwardly of the open end 106 or optionally flush with the open end 106. One of these diameter reductions provides a first annular shoulder 112 defining a valve seat for the first valve member 16. In the neutral, non-actuated state of the valve cartridge assembly 10, the first valve member 16 is spaced from the first annular shoulder 112. However, when the valve cartridge assembly 10 is actuated and the piston 30 is extended, the actuator body 24 and the first valve member 16 will move toward the left in FIG. 10, until the first valve member 16 is seated on the first annular shoulder 112. It will be appreciated that this movement of the actuator body 24 to the left will also cause the second valve member 34 to move out of engagement with the valve seat 88 of annular end portion 78.

Another of the diameter reductions of the valve chamber 104 provides a second annular shoulder 114 defining a support surface for the second distal end 40 of first spring member 18, i.e. the return spring. The first spring member 18 is under compression between the second annular shoulder 114 and the second end 28 of the actuator body 24, to bias the first valve member 16 away from the first annular shoulder 112.

The valve housing 100 also includes a plurality of valve ports 116, 118, 120, 122 through which fluid may enter or leave the valve chamber 104. The locations of these ports is exemplary only, and may vary depending on the specific application. It will be appreciated that the valve port 122, which forms a part of the stepped bore defining the valve housing 104, may function as a pressure relief or pressure bypass passage, depending upon the specific application.

It will be appreciated that housing 100 is shown as an example of a housing only, and that the valve cartridge assembly 10 is adaptable to a wide range of housing configurations with a range of port configurations. It will also be appreciated that the housing 100 may be a separate component of a vehicle's fluid circulation system or may be integrated with another component of the vehicle, such as a heat exchanger, transmission or other powertrain component, etc.

The valve cartridge assembly 10 described above includes a pair of valve members 16, 34 which are adapted to seal with respective valve seats 112 (formed in housing 100) and 88 (formed in valve cap). It is possible to provide at least some of the benefits described above in a simpler valve structure having a simpler structure, and including only a single valve member and valve seat. Such a valve cartridge assembly 130 is now described below. In the following description like reference

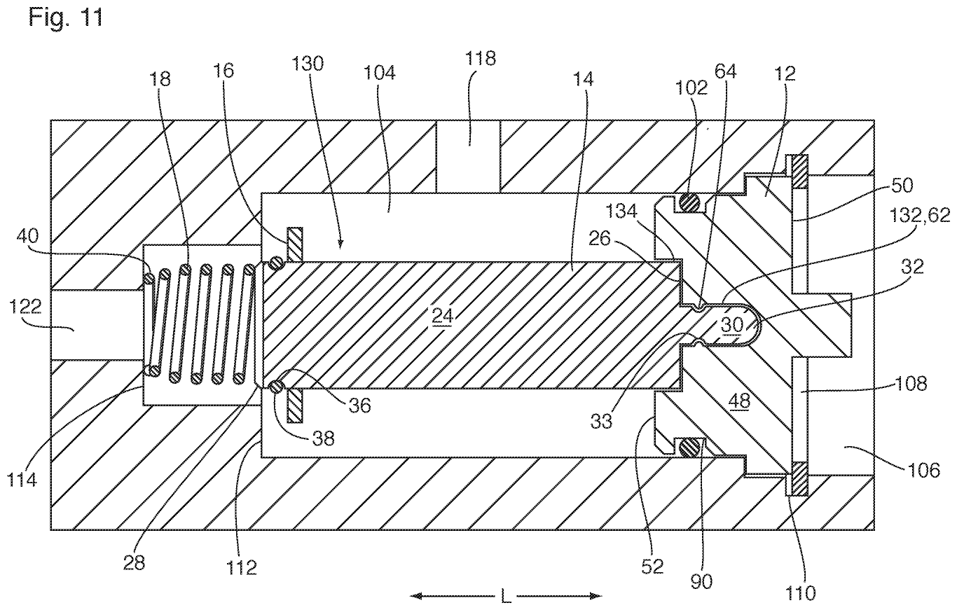

FIG. 11 shows a cross-sectional view of valve cartridge assembly 130 received in a housing 100. The valve cartridge assembly 130 includes a valve cap 12, a valve actuator 14, a first valve member 16, and a first spring member 18 which serves as a return spring.

The valve actuator 14 is similar to that of assembly 10 described above, having an actuator body 24 with a first end 26 and a second end 28 spaced apart along longitudinal axis L. The valve actuator 14 further comprises a piston 30 which extends axially from the first end 26 of actuator body 24, wherein the piston 30 is extendable and retractable along the longitudinal axis L, with FIG. 11 showing the retracted position. The piston 30 comprises a cylindrical metal shaft having a distal end 32 which may be rounded, and having an annular groove 33 on its outer surface, proximate to the distal end 32. The actuator 14 may be a thermal actuator as described above.

The first valve member 16 is rigidly secured to the second end 28 of actuator body 24, and may be integrally formed therewith. The first spring member 18 comprises a coil spring having a first proximal end 38 which is secured in the annular groove 36 at the second end 28 of valve body 24, and a second distal end 40 which projects axially away from the second end 28 of valve body 24, and is in engagement with the second annular shoulder 114 of housing 100.

The valve cap 12 includes a generally cylindrical valve closure cap 48 having a first end 50 and a second end 52, wherein the first end 50 faces outwardly from the open end 106 of the valve housing 100. The valve closure cap 48 has an outer cylindrical surface which is provided with an annular groove 90 adapted to receive a resilient sealing element 102 in the form of an O-ring.

The second end 52 of valve closure cap 48 is provided with an internal, longitudinally extending bore 132 which defines a central, axially-extending sleeve portion 62 which is adapted to receive the distal end 32 of piston 30 with an interlocking fit. The sleeve portion 62 has a generally cylindrical inner wall surface provided with an annular bead 64 projecting from the inner wall surface into the hollow interior of sleeve portion 62, the annular bead 64 being shaped and sized to be closely received inside the annular groove 33 close to the distal end 32 of piston 30. The bore 132 of valve closure cap 48 may be surrounded by a shallow recess 134 which is adapted to receive the first end 26 of actuator body 24.

The valve housing 100 has a hollow valve chamber 104 into which the valve cartridge assembly 130 is inserted through open end 106. The valve cartridge assembly 130 is locked in place by resilient spring clip 108 which may be a C-shaped metal ring having its outer portion received in an annular groove 110 just inside the open end 106, and an inner portion which engages the first end 50 of the valve closure cap 48. The valve chamber 104 has a generally cylindrical inner wall against which the outer cylindrical surfaces of the valve closure cap 48 and the annular end portion 78 are sealed. The seal between the valve closure cap 48 and housing 100 is made fluid-tight with the assistance of the O-ring 102 which is received in the annular groove 90 of the valve closure cap 48. The valve chamber 104 comprises a stepped bore which includes a first annular shoulder 112 defining a valve seat for the first valve member 16, and a second annular shoulder 114 defining a support surface for the second distal end 40 of first spring member 18. The first spring member 18 is under compression between the second annular shoulder 114 and the second end 28 of the actuator body 24, to bias the first valve member 16 away from the first annular shoulder 112.

The valve housing 100 also includes a plurality of valve ports 118 and 122 through which fluid may enter or leave the valve chamber 104. The locations of these ports is exemplary only, and may vary depending on the specific application.

While various embodiments have been described in connection with the present disclosure, it will be understood that certain adaptations and modifications of the described exemplary embodiments can be made as construed within the scope of the present disclosure. Therefore, the above discussed embodiments are considered to be illustrative and not restrictive.

What is claimed is:

1. A valve cartridge assembly comprising:
a valve actuator comprising an actuator body having a first end and a second end, and a piston which extends along a longitudinal axis from the first end of the actuator body, wherein the piston is extendable and retractable along the longitudinal axis;
a first valve member provided at the second end of the actuator body;
a second valve member provided at the first end of the actuator body;
a first spring member having a first end which is attached to the second end of the actuator body; and
a valve cap comprising:
(i) a valve closure cap adapted to seal against an inner wall of a valve housing, the valve closure cap having a first end and a second end;
(ii) a central, longitudinally extending sleeve portion adapted to receive a distal end of the piston, the sleeve portion having an open end, a hollow interior and a generally cylindrical inner wall surface;
wherein the distal end of the piston is received inside the sleeve portion with an interlocking fit.

2. The valve cartridge assembly of claim 1, wherein the valve cap further comprises:
(iii) an annular end portion longitudinally spaced from the valve closure cap and defining a central fluid opening, the annular end portion having a first face and a second face, wherein the second face defines an annular valve seat adapted to seal with the second valve member; and
(iv) a plurality of longitudinally extending struts extending between and attached to the second end of the valve closure cap and the first face of the annular end portion.

3. The valve cartridge assembly of claim 1, wherein the central, longitudinally extending sleeve portion projects from the second end of the valve closure cap.

4. The valve cartridge assembly of claim 1, wherein the central, longitudinally extending sleeve portion comprises an internal, longitudinally extending bore.

5. The valve cartridge assembly of claim 1, wherein the piston has an annular groove on its outer surface, proximate to the distal end thereof;
wherein the generally cylindrical inner wall surface of the sleeve portion is provided with an annular bead which is closely received inside the annular groove of the piston.

6. The valve cartridge assembly of claim 1, wherein the distal end of the piston is closely received inside the sleeve portion.

7. The valve cartridge assembly of claim 1, wherein the sleeve portion is provided with a plurality of axial slots extending from the open end of the sleeve portion toward the second end of the valve closure cap; and
wherein the slots separate the sleeve portion into a plurality of axially extending fingers which are flexible in radially inward and outward directions during insertion of the piston into the sleeve portion.

8. The valve cartridge assembly of claim 1, wherein the second valve element is integrally formed with the actuator body and comprises an annular surface at the first end of the actuator body.

9. The valve cartridge assembly of claim 1, wherein the valve actuator is a thermal actuator or an electronic actuator.

10. The valve cartridge assembly of claim 1, wherein the actuator body is generally cylindrical;
wherein the valve cartridge assembly further comprises a second spring member comprising a coil spring which extends around the actuator body; and
wherein the first valve element comprises an annular disc which is slidably received over the second end of the actuator body, between the first and second spring members.

11. The valve cartridge assembly of claim 1, wherein the second end of the actuator has an annular groove; and
wherein the first spring member has a first proximal end which is secured in the annular groove.

12. The valve cartridge assembly of claim 1, wherein the first end of the valve closure cap forms an outer surface of the valve cartridge assembly; and
wherein the first end of the valve closure cap is provided with a plurality of depressions which are shaped for engagement with a tool for inserting and removing the valve cartridge assembly from a valve housing.

13. The valve cartridge assembly of claim 12, wherein the depressions are wedge shaped and centrally arranged around a center of the end face, the depressions being separated by webs and surrounded by a flat, annular surface.

14. The valve cartridge assembly of claim 1, wherein the struts are arranged circumferentially and wherein spaces between the struts provide fluid flow passages.

15. The valve cartridge assembly of claim 14, wherein the valve cap comprises three struts which are circumferentially spaced apart from one another by about 120 degrees, and wherein the spaces between the struts are substantially greater in area than the struts themselves.

16. The valve cartridge assembly of claim 1, wherein the annular valve seat of the annular end portion is recessed relative to the second face of the annular end portion, such that the second valve member is at least partially received inside the annular ring portion when the piston is in a non-actuated, retracted position.

17. The valve cartridge assembly of claim 1, wherein the annular end portion has an outer surface which is provided with an annular sealing rib which is adapted to sealingly engage an inner surface of the valve housing.
